(19) United States
(12) Patent Application Publication
(10) Pub. No.: US 2022/0140510 A1
(43) Pub. Date: May 5, 2022

(54) CARD RETAINING MEMBER AND CARD CONNECTOR SET

(71) Applicant: Molex, LLC, Lisle, IL (US)

(72) Inventors: Kyoko MOTOHASHI, Yamato (JP); Hideo NAGASAWA, Lisle, IL (US)

(73) Assignee: Molex, LLC, Lisle, IL (US)

(21) Appl. No.: 17/429,956

(22) PCT Filed: Feb. 5, 2020
(86) PCT No.: PCT/JP2020/004357

§ 371 Date: Aug. 11, 2021

Related U.S. Application Data
(60) Provisional application No. 62/807,804, filed on Feb. 20, 2019.

(51) Int. Cl. H01R 12/70; H01R 12/71; G06K 19/077

(52) U.S. Cl. CPC H01R 12/7005; G06K 19/07743; H01R 12/714

(57) ABSTRACT

To enable compatibility with smaller, thinner, and multi-polarized cards, to enable miniaturization, flattening, and multi-polarization and increase reliability. Therefore, provided are: a tray housing including a recessed part capable of housing a card, a bottom wall part that defines the bottom surface of the recessed part, and a tray terminal housing recess formed on the bottom wall part; and tray terminals that are arranged on the bottom wall part which includes a main body at least part of which is retained by the bottom wall part, a first contact part and a second contact part that are connected to both ends of the main body part respectively, of which the first contact part is contactable to the connector terminal and the second contact part is contactable to the electrode pad; where the first contact part is fixed and exposed on the opposite side to the bottom surface of the recessed part of the bottom wall part, and the second contact part is housed in an elastically deformable manner in the tray terminal housing recess in a state where at least the point of contact thereof protrudes from the bottom surface of the recessed part.

### RELATED APPLICATIONS

This application is a National Phase of International Application No. PCT/JP2020/004357 filed on Feb. 5, 2020, which claims priority to U.S. Provisional Application No. 62/807,804, filed Feb. 20, 2019, the contents of which are incorporated herein by reference in their entireties.

### TECHNICAL FIELD

The present disclosure relates to a card retaining member and card connector set.

### BACKGROUND

Conventionally, electronic devices such as mobile phones, smart phones, and the like are provided with card connectors to utilize various cards such as a SIM (Subscriber Identity Module) card. In recent years, card and card connectors have trended towards rapid miniaturization with the rapid miniaturization of electronic devices. Therefore, it is difficult for a user to grasp a card using a finger or insert it appropriately into a card connector. Therefore, a card connector has been proposed in which a card is set in a card tray in advance and the card tray is inserted (see, for example, Patent Document 1).

FIG. 13 illustrates a conventional card connector.

In the diagram, 811 is a substrate of a card connector having an electrically conductive connection pad not shown on the surface formed thereon, and 861 is a shell of a card connector formed from a metal plate, covers above the connection pad, and is attached to the substrate 811. In addition, a card housing space 818 of the card connector is formed between the substrate 811 and the shell 861. Additionally, 971 is a card tray, and is inserted from the entry side of the card housing space 818 as indicated by the arrow in a state in which a card 901 is loaded therein and is housed in the card connector.

Note that a plurality of conductive members 951 are attached to the bottom plate of the card tray 971 and when the card 901 is loaded into the card tray 971, each of the plurality of electrode pads formed exposed on the bottom surface of the card 901 contacts a top surface of the corresponding conductive member 951. In a state in which the card tray 971 is housed in the card housing space 818, a lower surface of the tip end of each conductive member 951 contacts a connection pad formed on the surface of the substrate 811, such that the electrode pads of the card 901 and the corresponding connection pads of the card connector are connected via the conductive member 951.

In this manner, the card 901 is inserted into and housed in the card housing space 818 while being loaded into the card tray 971, and thus, when inserted into the card housing space 818, the card 901 does not contact the entry portion of the card housing space 818, and the electrode pads and the like are not harmed. In addition, since the electrode pads of the card 901 and the corresponding connection pads are connected via the conductive member 951, having elasticity, the conduction state between the electrode pad and the connection pad is stable.

Prior Art Documents; Patent Documents; Patent Document 1; Japanese Unexamined Patent Application Publication No. 2015-219988

### SUMMARY

### Problems to be Solved by the Disclosure

However, regarding the conventional card connector, the conductive member 951 attached to the bottom plate of the card tray 971 elastically deforms so as to maintain contact with the electrode pads of the card 901 and to maintain contact with the connection pads of the card connector, which necessitates an increase in the elastically deformable range of the conductive member 951, making it difficult to reduce the size of the conductive member 951. As a result, miniaturization of the card tray 971 becomes difficult, and it becomes difficult to reduce the size of the card connector containing the card tray 971.

Here, an object of the present disclosure is to resolve the aforementioned conventional problems to provide a highly reliable card retaining member and card connector set that can have a small size and low profile, in addition to enabling multi-polarization.

### Means for Solving the Problems

To that end, the card retaining member is a card retaining member capable of holding a card provided with electrode pads and can be inserted in a card connector provided with connector terminals, prepared with: a tray housing including a recessed part capable of housing the card, a bottom wall part that defines the bottom surface of the recessed part, and a tray terminal housing recess formed on the bottom wall part; tray terminals arranged on the bottom wall part, including a main body part of which at least one portion is retained by the bottom wall part, a first contact part and second contact part which are connected to both ends of the main body part, of which the first contact part is contactable to the connector terminal and the second contact part is contactable to the electrode pad; wherein the first contact part is fixed and exposed on the surface on the opposite side to the bottom surface of the recessed part of the bottom wall part, and the second contact part is retained in an elastically deformable manner in the tray terminal housing recess in a state where at least the point of contact thereof protrudes from the bottom surface of the recessed part.

In another card retaining member, furthermore, the second contact part is elastically deformable within the tray terminal housing recess without interfering with other members.

In still another card retaining member, the tray terminal is further arranged so as to form, in plan view, one or a plurality of second contact parts that are aligned in rows along the width direction orthogonal to the insertion direction of the card retaining member.

In still another card retaining member, the tray terminals are further arranged such that, in plan view, the main body part extends in the insertion direction of the card retaining member.

In still another card retaining member, tray terminals further include, in plan view, a tray terminal arranged such that the main body part extends in the insertion direction of the card retaining member and a tray terminal arranged such that the main body part extends in the width direction orthogonal to the insertion direction of the card retaining member.

In still another card retaining member, at least one tray terminal further includes, in plan view, a column direction portion arranged such that the main body part extends in the insertion direction of the card retaining member and a row direction portion arranged such that the main body part extends in the width direction orthogonal to the insertion direction of the card retaining member.

In still another card retaining member, the tray terminal further includes an incline direction portion connecting the column direction portion and the row direction portion.

The card connector set includes the card retaining member of the present disclosure, the card connector that can be inserted into the card retaining member, and a card connector provided with a connector terminal that is elastically deformable and includes a contact part contactable to the first contact part.

In another card connector set, the connector terminals are further arranged such that each connector terminal extends in the insertion direction of the card retaining member, and one or a plurality of contact parts are formed, in plan view, in rows aligned along the width direction orthogonal to the insertion direction of the card retaining member.

### Effects of the Disclosure

The card retaining member and card connector set can accept small, thin, and multi-polarized cards, enables miniaturization, flattening, and multi-polarization, and increases reliability.

### BRIEF DESCRIPTION OF THE DRAWINGS

FIG. 1 is a perspective view illustrating a card connector set in which a card holding tray is inserted into a connector according to embodiment 1.

FIG. 2 is an exploded view of the card connector set according to embodiment 1.

FIG. 3 is a perspective view of a card connector set in which a tray that is not holding a card is inserted into the connector according to embodiment 1 in a state where the connector cover has been removed.

FIG. 4 is an exploded view of the portion of the connector according to embodiment 1, other than the connector cover.

FIGS. 5A and 5B illustrate two views of the card connector set in which a card holding tray is inserted into the connector according to embodiment 1, where FIG. 5A is an upper surface view, and FIG. 5B is a sectional view taken along the line A-A in FIG. 5A.

FIGS. 6A and 6B are two views of the card connector set in which a card holding tray is inserted into the connector according to embodiment 1, in a state where the connector cover has been removed, where FIG. 6A is an upper surface view, and FIG. 6B is a sectional view taken along the line A-A in FIG. 6A.

FIG. 7 is a cross-sectional perspective view of a card connector set in which a card holding tray is inserted into a connector according to embodiment 1.

FIG. 8 is a perspective view of a card connector set in which a tray that is not holding a card is inserted into the connector according to embodiment 2, in a state where the connector cover has been removed.

FIG. 9 is a bottom view of the card according to embodiment 2.

FIG. 10 is an exploded view of the tray according to embodiment 2.

FIG. 11 is an upper surface view illustrating the arrangement of the tray terminals according to embodiment 2.

FIGS. 12A, 12 B and 12 C are views of a card connector set in which a tray is inserted into a connector according to embodiment 2, in a state where the connector cover has been removed, where FIG. 12A is an upper surface view in a state where the tray is not holding a card, FIG. 12B is a sectional view taken along the line B-B in FIG. 12A, and FIG. 12C is a diagram illustrating a state where the tray is holding a card, a sectional view taken along the line C-C in FIG. 12A.

FIG. 13 is a diagram illustrating a conventional card connector.

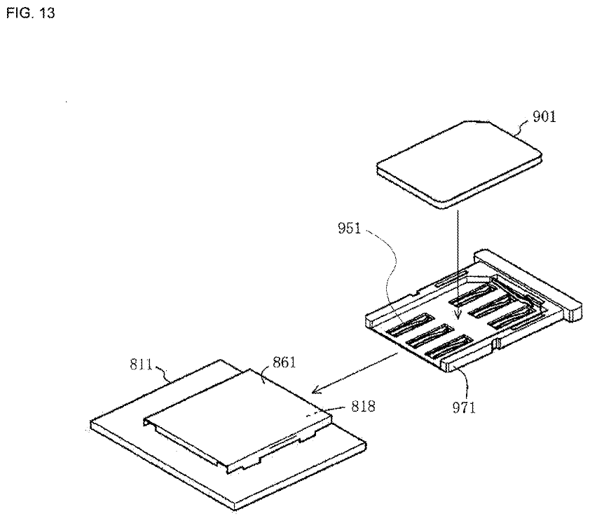

### DETAILED DESCRIPTION OF THE PREFERRED EMBODIMENTS

Embodiments will hereinafter be described in detail with reference to the drawings.

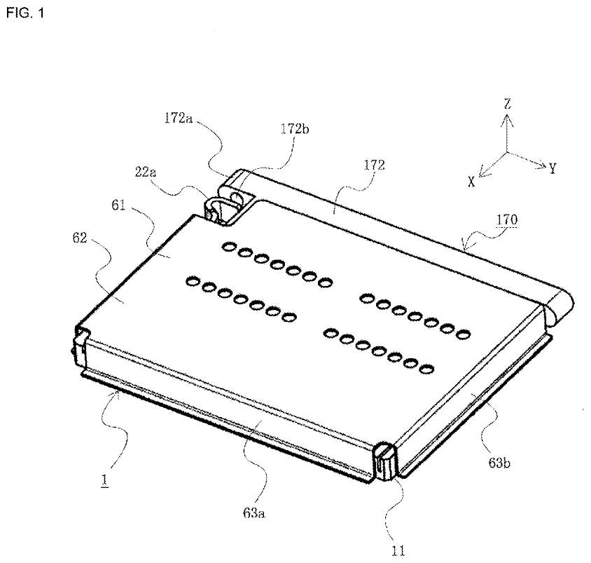

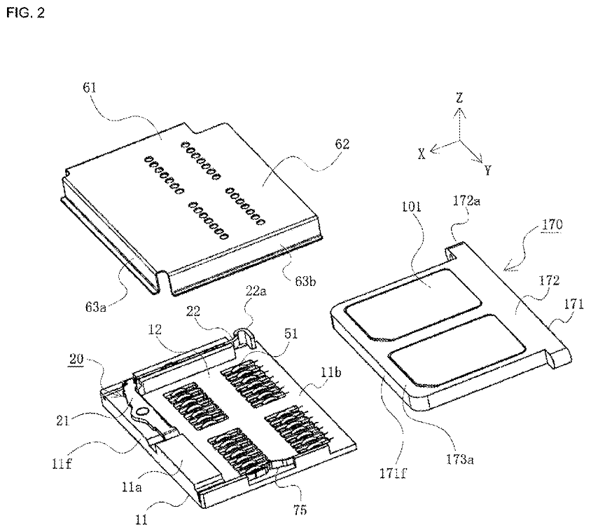

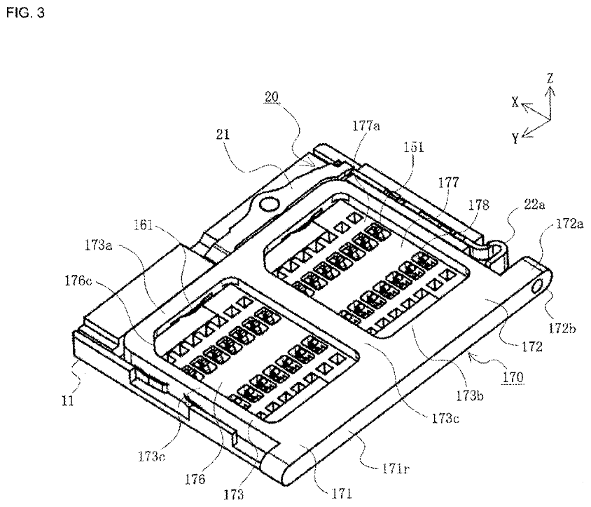

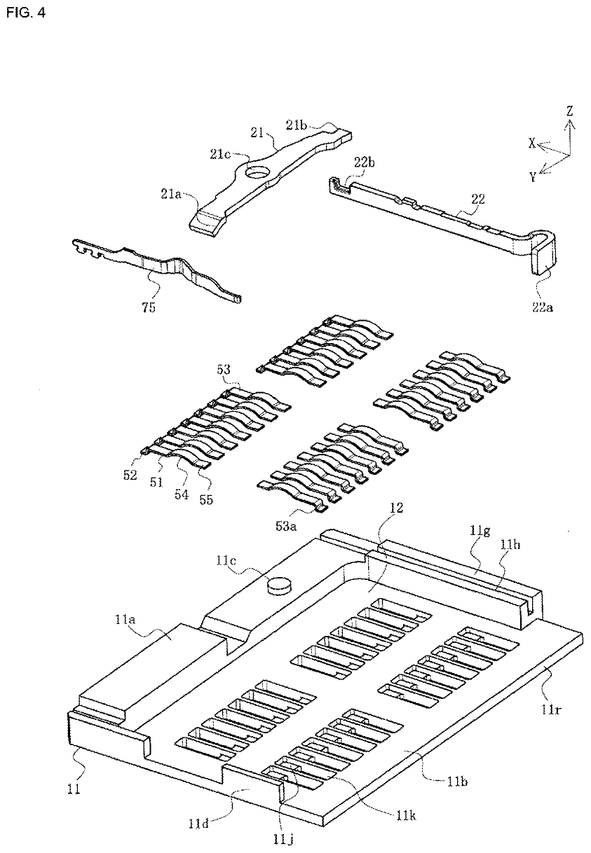

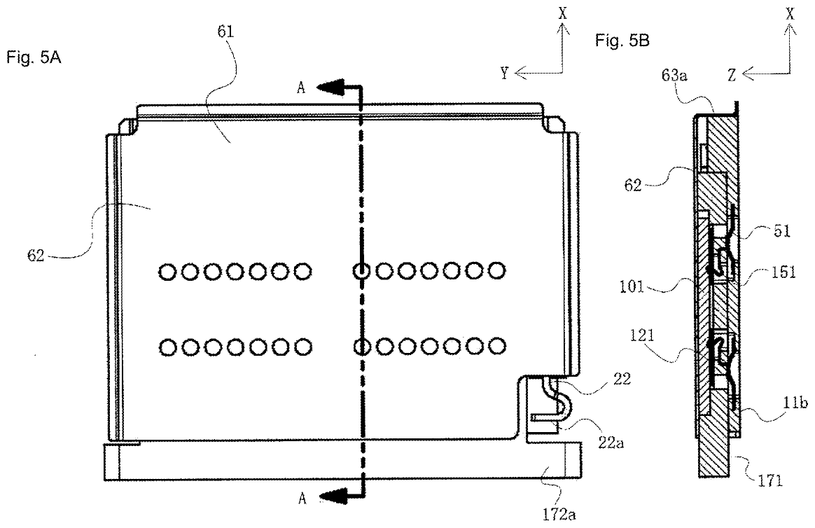

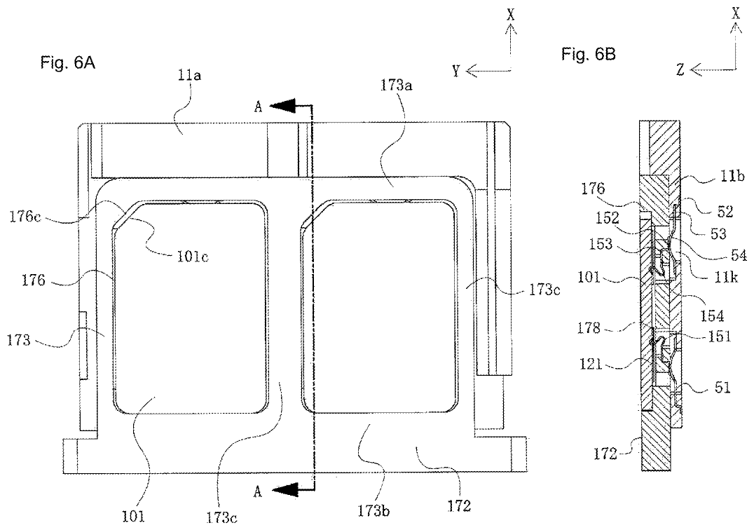

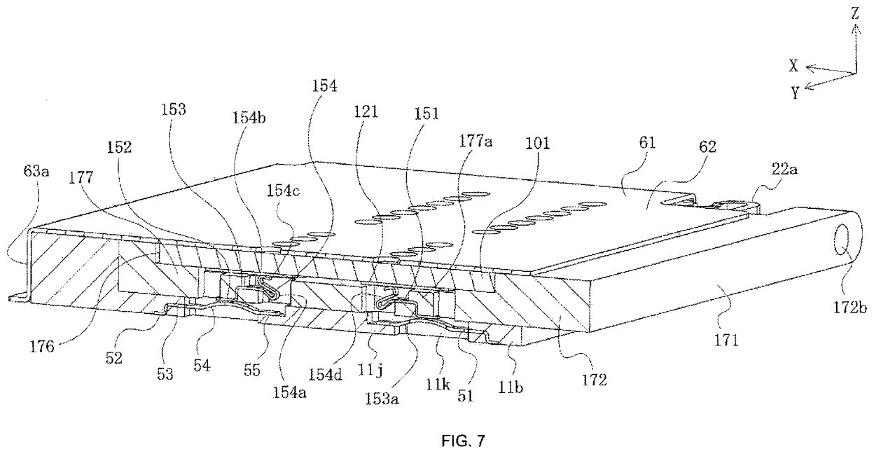

FIG. 1 is a perspective view illustrating card connector set in which a card holding tray is inserted into a connector according to embodiment 1. FIG. 2 is an exploded view of the card connector set according to embodiment 1. FIG. 3 is a perspective view of a card connector set in which a tray that is not holding a card is inserted into the connector according to embodiment 1, in a state where the connector cover has been removed. FIG. 4 is an exploded view of the portion of the connector according to embodiment 1, other than the connector cover. FIGS. 5A and 5B are two views of a card connector set in which a card holding tray is inserted into a connector according to embodiment 1. FIGS. 6A and 6B are two views of a card connector set in which a card holding tray is inserted into the connector according to embodiment 1, in a state where the connector cover has been removed. FIG. 7 is a cross-sectional perspective view of a card connector set in which a card holding tray is inserted into a connector according to embodiment 1. Note that in FIGS. 5A and 5B and FIGS. 6A and 6B, FIG. 5A and FIG. 6A are upper surface views and FIG. 5B and FIG. 6 Bare sectional views taken along the line A-A in FIG. 5A and FIG. 6A.

In the diagrams, 170 is a tray as the card retaining member according to the present embodiment, and is inserted into a connector 1 as a card connector mounted on a circuit board of an electronic device (not shown), in a state in which a card 101 is housed. Thus, the card 101 is mounted to the electronic device via the tray 170 and the connector 1.

Here, the card connector set description includes the tray 170 to which the card 101 is electrically connected, and a connector 1 to which the tray 170 is inserted in the same direction as the planar direction of the circuit board of the electronic device, and which is electrically connected to the tray 170, and the card connector set is used to connect the card 101 and the electronic device.

Note that in the present embodiment, the card 101 can be, for example, a memory card itself such as a SIM card, micro SIM card, an MMC®, and SD® card, miniSD® card, xD picture Card®, Memory Stick®, Memory Stick Duo®, Smart Media®, Trans-Flash®, and the like or a card adapter that internally houses a memory card provided with the appropriate shape and dimensions to be inserted into the connector 1, such as a SD® card adapter that houses internally a miniSD® card.

Furthermore, the electronic device can be any kind of device, for example, a personal computer, a mobile phone, a smartphone, a communication modem, a pad-type computer, a digital camera, a video camera, a music player, a game console, a vehicle navigation device, and the like. The circuit board of the electronic device is a printed circuit board, a flexible flat cable, a flexible printed circuit board, and the like used in electronic devices and the like, but can be one of a variety of types of circuit boards.

Note that in the present embodiment, expressions indicating direction such as top, bottom, left, right, front, rear, and the like used to describe a configuration and operation of each part of the tray 170 and connector 1 are relative rather than absolute, and are proper when each part of the tray 170 and connector 1 are in positions illustrated in the diagrams, but should be changed and interpreted according to a change in position with a change in posture of the tray 170 and connector 1.

The tray 170 is explained below.

As illustrated in the diagram, the tray 170 includes a tray housing 171 with a recessed part 176 on which the card 101 can be mounted, and a plurality of tray terminals 151 connectable with electrode pads 121 exposed on lower surface (electrode pad surface) of the card 101 in the recessed part 176. Note that the tray housing 171 is an integrally molded member made of an insulating material, and each tray terminal 151 is a member integrally formed of a conductive metal plate by punching, bending, or the like. The tray terminals 151 are preferably integrated with the tray housing 171, for example, by a molding method such as insert molding (overmolding).

In the example illustrated in the diagrams, two recessed parts 176 are arranged side by side in the width direction (Y axis direction) of the tray housing 171, there does not necessarily need to be two recessed parts 176, such that there can be one, or there can be three or more. Also, the recessed parts 176 do not necessarily need to be aligned in the width direction of the tray housing 171 and may be aligned in the front-rear direction of the tray housing 171 (the insertion and ejection direction of the tray 170, or in other words, the X-axis direction). Furthermore, the plurality of recessed parts 176 do not necessarily need to have the same size and shape as each other, but may be different in size and shape. Note that, for convenience of explanation, a case in which two recessed parts 176 having the same size and shape as each other are arranged side by side in the width direction of the tray housing 171, as in the example illustrated in the diagrams, will be used.

The tray housing 171 includes a base part 172 that extends in the width direction, and a frame part 173 connected to the front of the base part 172. The frame part 173 includes a front frame part 173 a that defines the front end edge of the recessed part 176, a rear frame part 173b that defines the rear end edge of the recessed part 176, and a side frame part 173c that defines the side end edge of the recessed part 176. The front frame part 173a is an elongated portion that extends in the width direction at the front end of the tray housing 171, and the front end surface thereof is a front end surface 171f of the tray housing 171. The rear frame part 173b is an elongated portion that is integrated with the base part 172 and extends in the width direction parallel to the front frame part 173a. Furthermore, the side frame part 173c is a plurality of elongated portions extending in the front-rear direction parallel to each other, and the front and rear ends of the side frame part 173c are connected to the front frame part 173a and the rear frame part 173b. A flange part 172a protruding outward in the width direction is preferably formed at one end (the right end in FIG. 5A) in the width direction of the base part 172, and an operation insertion hole 172b is preferably formed in the flange part 172a so as to penetrate in the front-rear direction. Furthermore, a rear end surface of the base part 172 is the rear end surface 171r of the tray housing 171.

In the example illustrated in the diagrams, the recessed part 176 is a recessed part in which the shape in the front-rear direction is substantially rectangular, larger than the width direction dimension, and the bottom surface thereof is closed by the flat bottom wall part 177, and the top surface thereof is open. Note that in order to prevent erroneous mounting of the card 101 to the recessed part 176, a polarity-imparting protruding part 176c having a diagonal shape when viewed planarly is preferably formed so as to correspond to a notch 101c formed in a portion corresponding to one corner of the rectangle of the card 101. In addition, because the recessed part 176 is a housing space capable of housing the card 101, the size and shape of the recessed part in a plan view thereof is the same as the size and shape of the card 101 in a plan view, and the depth (dimension in the Z-axis direction) of the card 101 is substantially the same as the thickness (dimension in the Z-axis direction) of the card 101.

Furthermore, the front frame part 173a, the rear frame part 173b, and the side frame part 173c functions as side walls of the recessed part 176, and face the side surfaces of the card 101 housed in the recessed part 176. Note that, as illustrated in FIG. 3, a portion of the side wall part may be provided with a retaining part 161 for preventing the housed card 101 from falling or dropping out. The retaining part 161 is an elastically deformable portion, a part of which protrudes into the recessed part 176, which is a housing space, and biases the side surface of the housed card 101 to hold the card 101. Note that the retaining part 161 is not limited to such a configuration, and may have any configuration as long as the card 101 is held in the recessed part 176 without falling or dropping out.

In addition, a plurality of tray terminal housing recesses 178 are formed in the bottom wall part 177, one tray terminal 151 is arranged in each tray terminal housing recess 178, and a second contact part 154 thereof is housed. The tray terminal housing recess 178 does not necessarily need to be a through-hole, but is described here as being a through-hole penetrating through the bottom wall part 177 in the plate thickness direction to the vertical direction (Z-axis direction). Also, while the tray terminals 151 do not necessarily need to be arranged in all of the tray terminal housing recesses 178, the tray terminals 151 are described here as being arranged in each of the tray terminal housing recesses 178. The tray terminal housing recesses 178 and the tray terminals 151 are arranged so as to correspond to the arrangement of the electrode pads 121 on the bottom surface of the card 101 housed in the recessed part 176, and in the example illustrated in the diagrams, two rows are formed in the front and back of the rows aligned in the width direction. In addition, a terminal retention part 177a that retains the tray terminal 151 is arranged in each tray terminal housing recess 178. The terminal retaining part 177a is formed so as to cross the tray terminal housing recess 178 in the width direction.

The tray terminal 151 is a member formed by punching, bending, or other processing of an electrically conductive metal plate and has a main body part 153, a first contact part 152 connected to one end of the main body part 153, and a second contact part 154 connected to the other end of the main body part 153.

The main body part 153 includes a bend 153a bent in a crank shape in a side view and is held by the terminal retention part 177a at least partially embedded in the terminal retention part 177a.

Furthermore, the first contact part 152 is a flat plate-shaped portion connected to the lower end of the bend 153a, and a bottom surface thereof is fixed to and exposed on the lower surface of the bottom wall part 177 (in the illustrated example, the terminal retaining part 177a), and is in contact with and electrically conductive with the connector terminal 51 of the connector 1. As illustrated in the diagram, the lower surface of the first contact part 152 is preferably positioned substantially flush with the lower surface of the bottom wall part 177, that is, it is flush. This allows the tray 170 to be smoothly inserted into the connector 1 without the tray 170 pulling on the connector 1 when the tray 170 is inserted into the connector 1. However, the bottom surface of the first contact part 152 does not necessarily need to be substantially flush with the lower surface of the bottom wall part 177, as long as at least a portion thereof is exposed on the lower surface of the bottom wall part 177. That is, if the protruding amount of the bottom surface of the first contact part 152 and the lower surface of the bottom wall part 177 is such that operating efficiency when the tray 170 is inserted into the connector 1 is not reduced, the lower surface of the first contact part 152 and the lower surface of the bottom wall part 177 do not necessarily need to be positioned on the same plane. Note that in the example illustrated in the diagrams, the first contact part 152 is configured to not elastically deform, but can be formed in a shape that can deform elastically.

The second contact part 154 has a substantially S-shaped shape in a side view, and includes a first curved part 154a and a second curved part 154b each curved approximately 180 degrees, and a point of contact 154c connected to the second curved part 154b, the point of contact 154c being a contact point that makes contact with the electrode pad 121 on the lower surface of the card 101 and is electrically conductive. The area from the connecting part with the main body part 153 to the point of contact 154c in the second contact part 154 includes a first curved portion 154a and a second curved portion 154b, and is an elastically deformable elastic deformation portion 154d. When at least the point of contact 154c protrudes from the bottom surface of the recessed part 176 and the point of contact 154c is pressed by the electrode pad 121 of the card 101, the elastic deformation portion 154d is elastically deformed, and the point of contact 154c and the electrode pad 121 can be brought into elastic contact. Furthermore, the elastic deformation portion 154d is located in the tray terminal housing recess 178 of the bottom wall part 177, and does not contact other members or locations even when elastically deformed. As a result, excessive elastic force is not applied to the electrode pads 121 of the card 101, and the electrode pads 121 are not harmed or damaged.

Next, the configuration of the connector 1 will be described.

As illustrated in the diagrams, the connector 1 includes a housing 11 that is provided with a recessed part 12 that houses the tray 170, a connector cover 61 that covers the housing 11, a connector terminal 51 connectable with the tray terminal 151, and an ejection mechanism 20 for ejecting the tray 170 inserted into the connector 1.

The housing 11 is an integrally molded member made of an insulating material and includes a bottom wall part 11b as a substantially rectangular flat plate-shaped terminal retaining part, a rear wall part 11 a that extends in the width direction along a front end portion of the housing 11 in the insertion direction (X-axis direction) of the tray 170, and is thicker than the bottom wall part 11b, a pair of side wall parts 11d that extend in the insertion direction along both left and right side edges of the housing 11 and are thicker than the bottom wall part 11b, and a pushrod retaining part 11g integrally formed with the side wall 11d (right side in the insertion direction of the tray 170 in the example illustrated in the diagrams). Note that a pushrod housing groove 11h extending in the insertion direction is formed in the pushrod retaining part 11g. The other side wall part 11d (in the example illustrated in the diagram, the left side in the insertion direction of the tray 170) may be provided with a retaining part 75 for preventing the tray 170 housed in the recessed part 12 from falling or dropping out. The retaining part 75 is an elastically deformable portion, a part of which protrudes into the recessed part 12, which is a housing space, and biases the side surface of the housed tray 170 to hold the tray 170. Note that the retaining part 75 is not limited to such a configuration, and may have any configuration as long as the tray 170 is held in the recessed part 12 without falling or dropping out. In addition, when the tray 170 is held in the recessed part 12 by other means, such as the elasticity of the connector terminals 51, for example, the retaining part 75 does not necessarily need to be provided.

The rear wall part 11a, the side wall part 11d, and the pushrod retaining part 11g have a lower surface flush with the bottom surface of the bottom wall part 11b, and a top surface thereof is positioned above the top surface of the bottom wall part 11b. Note that the end surface in front of the insertion direction of the housing 11 is referred to as a front end surface 11f, and the end surface that is rearward in the insertion direction is referred to as a rear end surface 11r.

In addition, a plurality of connector terminal housing recessed parts 11k are formed in the bottom wall part 11b, and one connector terminal 51 is housed in each connector terminal housing recess 11k. The connector terminal housing recess 11k does not necessarily need to be a through-hole, but will be described here as being a through-hole penetrating through the bottom wall part 11b in the plate thickness direction to the vertical direction (Z-axis direction). In addition, the connector terminals 51 do not necessarily need to be housed in the connector terminal housing recess 11k. The connector terminal housing recess 11k and the connector terminals 51 are arranged so as to correspond to the arrangement of the first contact part 152 of the tray terminal 151 exposed on the bottom surface of the bottom wall part 177 of the tray 170 housed in the recessed part 12, and in the example illustrated in the diagrams, a plurality of connector terminals 51 are arranged so that two rows aligned in the width direction are formed. In addition, a terminal supporting part 11j that supports the tip end part 55 of the connector terminal 51 is arranged within each connector terminal housing recess 11k. The terminal supporting part 11j is arranged at one end in the longitudinal direction within the connector terminal housing recess 11k.

The connector terminal 51 is a member formed by punching, bending, or the like on a metal plate, and has a main body part 53, a connecting part 52 connected to one end of the main body part 53, a contact part 54 connected to the other end of the main body part 53, and a tip end part 55 connected to the end of the contact part 54. Note that the connector terminal 51 is preferably integrated with the housing 11 by a molding method such as, for example, insert molding (overmolding).

The main body part 53 includes a bend 53a bent in a crank shape in a side view and is held by the bottom wall part 11b at least partially embedded in the bottom wall part 11b.

Further, the connecting part 52 is a flat plate-shaped portion connected to the lower end of the bend 53a, and a lower surface thereof is exposed on the lower surface of the bottom wall part 11b, and is connected to a connection pad exposed on the top surface of the circuit board of the electronic device by a connection means such as soldering. Note that, in the example illustrated in the diagrams, the lower surface of the connecting part 52 is positioned substantially flush with the lower surface of the bottom wall 11b, that is, the surfaces are flush, but the lower surface of the connecting part 52 and the lower surface of the bottom wall 11b do not necessarily need to be substantially flush, for example, the lower surface of the connecting part 52 may be positioned below the lower surface of the bottom wall 11b.

The contact part 54 has a curved shape so as to bulge upward in a side view and is elastically deformable. The upper portion of the contact part 54 is positioned above the top surface of the bottom wall 11b so as to be able to contact the first contact part 152 of the tray terminal 151 exposed on the bottom surface of the bottom wall part 177 of the tray 170 housed within the recessed part 12. The contact part 54 elastically deforms when pressed by the first contact part 152 of the tray terminal 151, and thus can elastically contact the first contact part 152. Furthermore, the contact part 54 is positioned within the connector terminal housing recess 11k and does not contact other members or portions even when elastically deformed.

The tip end part 55 connected to the tip of the contact part 54 has a flat plate-shape, and the lower surface thereof abuts the upper surface of the terminal supporting part 11j and is supported from below by the terminal supporting part 11j. As a result, the contact part 54 functions as a leaf spring supported at both ends in the longitudinal direction, so the elastic force is improved, and the contact state with the first contact part 152 is stably maintained. Note that, in a case where the elastic force of the contact part 54 is sufficiently large, for example, the lower surface of the tip end part 55 does not necessarily have to abut the upper surface of the terminal supporting part 11j.

The ejection mechanism 20 includes an eject lever 21 as an ejection lever member, and a pushrod 22 as an ejection operating member.

The pushrod 22 is a generally straight rod or band shaped member, and is slidably mounted in the pushrod housing groove 11h of the pushrod retaining part 11g in the front-rear direction (insertion and ejection direction of the tray 170). A bent operating part 22a is integrally connected to the rear end of the pushrod 22. Further, an engagement part 22b that engages with the force point 21b of the eject lever 21 is formed on the front end of the pushrod 22. Note that, in a state where the tray 170 is housed in the recessed part 12, the operation insertion hole 172b formed in the flange part 172a of the tray housing 171 opposes the operating part 22a of the pushrod 22. Therefore, the operation part 22a can be pushed forward by inserting a thin rod-shaped operation member (not shown) in the operation insertion hole 172b.

The eject lever 21 is pivotally attached to a support shaft 11c formed on the rear wall part 11a at a fulcrum 21c thereof. In addition, the end part on the opposite side to the force point 21b across from the fulcrum 21c of the eject lever 21 acts as an action point 21a that contacts the front end surface 171f of the tray housing 171 housed of the tray 170 in the recessed part 12 to impart a force in the ejection direction to the tray 170. Thus, when a pressing force directed forward with respect to the operating part 22a is applied from an operating member inserted through the operation insertion hole 172b, a pressing force directed forward from the pushrod 22 to the force point 21b is transmitted. As a result, a force in the ejection direction is applied from the action point 21a to the tray housing 171, and the tray 170 is ejected from the recessed part 12 toward the rear.

The connector cover 61 is a member that covers the top surface of the housing 11, and is desirably a member formed by punching, bending, or the like on an electrically conductive metal plate, and includes a flat plate-shaped top plate part 62, a front plate part 63a rising from the front edge of the top plate part 62, and side plate parts 63b that rise from the pair of left and right side end edges of the top plate part 62. Furthermore, when the connector cover 61 is attached to the housing 11, the top plate part 62 extends parallel to the bottom wall part 11b, covers the top of the recessed part 12, and the recessed part 12 and the top plate part 62 form a space that houses the tray 170. Further, the front plate part 63a covers the outer surface of the front end surface 11f of the housing 11, the side plate part 63b covers the outer surface of the side wall 11d, and the lower end thereof is connected to a connection pad exposed on the top surface of a circuit board of the electronic device by a connecting means such as soldering. Note that the exterior of the rear end surface 11r of the housing 11 is left open without being covered by the connector cover 61, such that the rear end surface of the connector 1 is left open and functions as an insertion port for the tray 170. In addition, the connector cover 61 does not necessarily need to be made of metal, but in that case, the effect of suppressing noise generated from the card 101, electronic equipment, and the like cannot be expected of the connector cover 61.

Next, operation of the card connector set of the configuration described above will be explained. First, the operation of inserting the tray 170 into the connector 1 will be explained.

Here, the connector 1 is mounted to the circuit board by electrically connecting the connecting part 52 and the like of the connector terminal 51 to a connection pad of a circuit board of the electronic device by a connection means such as soldering.

First, the operator houses the card 101 in the recessed part 176 in accordance with the shape of the recessed part 176 in the tray 170. Specifically, as illustrated in FIG. 6A, the card 101 is placed in the recessed part 176 by controlling the position of the card 101 so that the notches 101c of the card 101 correspond to the polarity-imparting protruding parts 176c of the recessed part 176. As a result, the card 101 is housed in the recessed part 176 in an appropriate posture, or in other words, in a posture in which the lower surface thereof faces the bottom wall part 177, and each of the electrode pads 121 on the lower surface correspond to the corresponding tray terminals 151. At this time, in a case where the tray 170 includes the retaining part 161, the card 101 is biased against the frame part 173 of the housing 171 of the tray 170, and thus does not drop or fall off out of the recessed part 176. In this state, the electrode pad 121 on the bottom surface of the card 101 is not subjected to the elastic force from the tray terminal 151, and is in contact with the second contact part 154 of the tray terminal 151 by a force of the weight of the card 101.

Next, the operator inserts the tray 170 to a prescribed position in the housing space of the connector 1 while moving the tray 170 in the insertion direction toward the insertion opening of the tray 170 formed by the housing 11 and the connector cover 61 of the connector 1, and completes the insertion. In this state, the elastic force of the tray terminal 151 acts on the electrode pad 121 of the card 101. In other words, because the upper surface of the card 101 (the surface on which the electrode pad 121 is not formed) is prevented from moving upward by at least partially abutting the top plate part 62 of the connector cover 61, the tray terminal 151 can reliably apply an elastic force to the electrode pad 121 of the card 101. More specifically, as illustrated in FIG. 7, the elastic deformation 154d of the second contact part 154 of the tray terminal 151 elastically deforms, and the elastic force generated thereby causes the point of contact 154c of the second contact part 154 to be pressed against the electrode pad 121. Since the second contact part 154 has a substantially S-shaped shape in a side view and has a sufficient spring length, the elastic range of motion of the point of contact 154c located at the free end thereof is sufficiently large, and it is possible to exhibit sufficiently large elastic force.

Similarly, because the upper surface of the tray 170 also abuts with the top plate part 62 of the connector cover 61 and upward movement is prevented, the connector terminal 51 can reliably apply an elastic force to the first contact part 152 of the tray terminal 151. More specifically as illustrated in FIG. 7, the contact part 54 of the connector terminal 51 elastically deforms, and due to the elastic force generated thereby, the top portion of the contact part 54 having a curved shape so as to bulge upward is pressed by the first contact part 152 of the tray terminal 151. Because the contact part 54 functions as a leaf spring supported at both ends in the longitudinal direction, the elastic range of movement of the top portion is sufficiently large, and where a sufficiently large elastic force can be exerted.

Thus, since the tray terminals 151 and the connector terminals 51 are connected with the added elastic force exerted by the terminals thereof, the electrode pad 121 of the card 101 and the connection pad of the circuit board are electrically connected securely and stably via the tray 170 and the connector 1 of the card connector set.

Next, the operation of discharging the tray 170 from the connector 1 will be explained.

First, the operator inserts a thin rod-shaped operating member (not shown) such as a pin, rod, or the like from behind the tray 170 through the operation insertion hole 172b formed in the flange 172a of the tray housing 171 and brings the tip of the operating member into contact with the operating part 22a of the pushrod 22. Then, when the operator pushes the pushrod 22 forward via the operating member, the force point 21b of the eject lever 21 engaged with the engagement part 22b of the pushrod 22 is displaced forward. As such, the front end surface 171f of the tray housing 171 is pushed by the action point 21a of the eject lever 21, and the tray 170 is displaced from the prescribed position toward the direction (ejection direction) of the rear end surface 11r of the housing 51. At this time, the retaining part 75 biases the side of the tray 170 to hold the tray 170, but as force that the operator pushes the pushrod 22 via the operating member is considered to be sufficiently large, retention of the tray 170 by the retaining part 75 is easily eliminated, and the tray 170 moves toward the rear end surface 11r of the housing 51 and is ejected from the connector 1. The operator can then easily remove the ejected tray 170 from the connector 1. Note that the ejection mechanism 20 is not limited to the present embodiment, and may be a known mechanism such as a push-push method or a manner in which the tray 170 is pinched by a finger, or may be any mechanism that can eject the tray 170.

In this manner, the tray 170 and card connector set in the present embodiment can electrically connect the card 101 and a circuit board (not shown) with the card 101 housed in the tray 170. Therefore, the electrode pads 121 of the card 101 can be electrically connected to the connector terminals 51 without sliding with the connector terminals 51 and can prevent the electrode pads 121 of the card 101 from being harmed or damaged.

Note that in the present embodiment, the tray 170 includes two recessed parts 12, that is, a space to house two cards 101, but the number of recessed parts 12 may be one or three or more, and may be any number. Also, while the plurality of tray terminals 151 or the plurality of connector terminals 51 are arranged to form two rows in the bottom wall part 177 of the tray housing 171 or the bottom wall 11b of the housing 11, the number of rows of tray terminals 151 or connector terminals 51 may be one row or three rows or more, and may be any number. Furthermore, each tray terminal 151 or each connector terminal 51 held in the first and second rows of the tray terminals 151 or the connector terminals 51 may be arranged so that their orientation is in the opposite orientation with respect to the insertion and ejection direction (front-rear direction), but may be arranged so as to be oriented in the same direction, or may be arranged in any direction.

Thus, in the present embodiment, the tray 170 is capable of retaining the card 101 provided with an electrode pad 121, which can then be inserted into the connector 1 provided with the connector terminal 51. Furthermore, the tray 170 comprises: a tray housing 171 including a recessed part 176 capable of holding a card 101, a bottom wall part 177 that defines the bottom surface of the recessed part 176, and a tray terminal housing recess 178 formed on the bottom wall part 177; and tray terminals 151 arranged on the bottom wall part 177, including a main body part 153 of which at least a portion is retained by the bottom wall part 177, a first contact part 152 and a second contact part 154 which are connected to both ends of the main body part 153, of which the first contact part 152 is contactable to the connector terminal 51 and the second contact part 154 is contactable to the electrode pad 121; wherein the first contact part 152 is fixed and exposed on the opposite side to the bottom surface of the recessed part 176 of the bottom wall part 177, and the second contact part 154 is housed in an elastically deformable manner in the tray terminal housing recess 178 in a state where at least the point of contact 154c thereof protrudes from the bottom surface of the recessed part 176.

The card connector set includes a tray 170 and a connector 1 into which the tray 170 can be inserted; the connector 1 includes a connector terminal 51 that is elastically deformable and includes a contact part 54 that is capable of contacting the first contact part 152.

Accordingly, regarding the tray terminals 151 retained in the tray housing 171, the first contact part 152 that can contact the connector terminal 51 of the connector 1 is fixed, and only the second contact part 154 that can contact the electrode pad 121 of the card 101 can be elastically deformed, which enables suppressing the thickness of the tray housing 171 (the dimension in the vertical direction) even if the elastic deformation range of the second contact part 154 is made larger, enabling the tray 170 to become smaller and thinner. As a result, the entire card connector set can be made smaller and thinner, and can also support a card 101 having a large number of multi-polarized electrode pads 121. Therefore, it is possible to provide a highly reliable tray 170 and card connector set that can be miniaturized and flattened, as well as multi-polarized.

In addition, the second contact part 154 is elastically deformable without interfering with other members in the tray terminal housing recess 178. Furthermore, in a plan view, the second contact part 154 of the tray terminals 151 are arranged so as to form a row or rows aligned along the width direction orthogonal to the insertion direction of the tray 170. Furthermore, the tray terminals 151 are arranged so that in plan view the main body part 153 extends in the insertion direction of the tray 170. Furthermore, each of the connector terminals 51 extends in the insertion direction of the tray 170, and the contact part 54 is arranged so as to form, in a plan view, a row that is aligned along a width direction orthogonal to the insertion direction of the tray 170.

Next, Embodiment 2 will be described below. Note that, for portions having the same structure as that of Embodiment 1, descriptions thereof are omitted by giving the same reference numerals thereto. Moreover, descriptions of the same operations and effects as those of Embodiment 1 will be omitted.

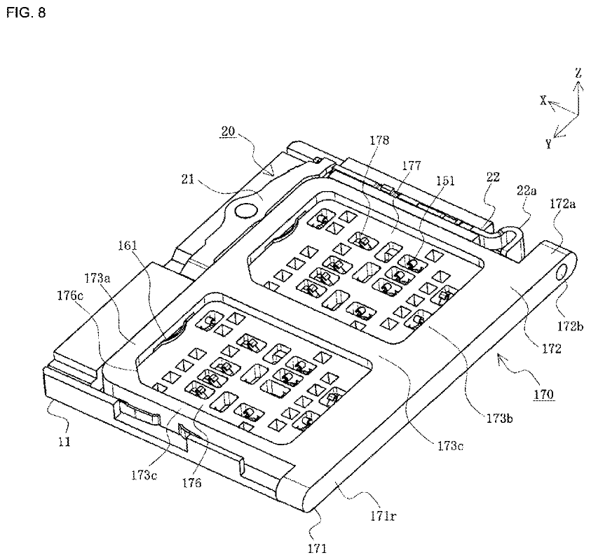

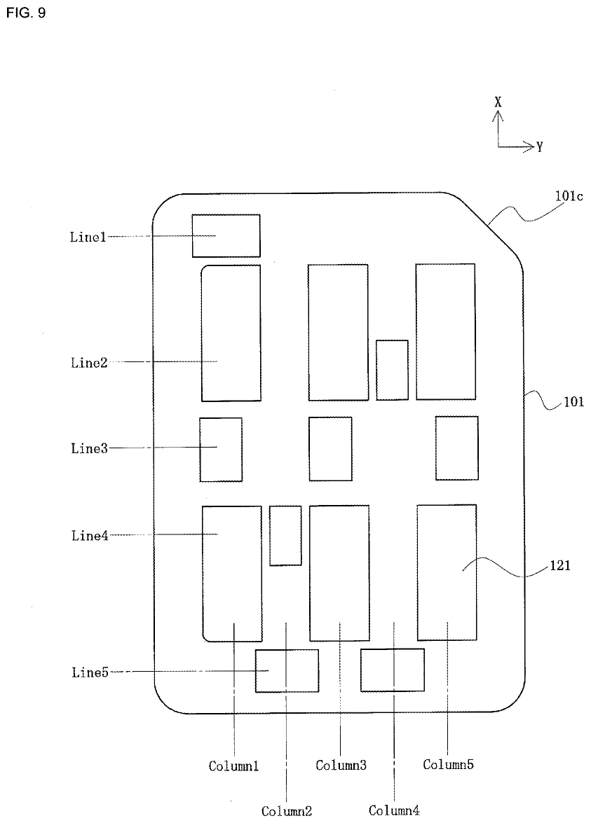

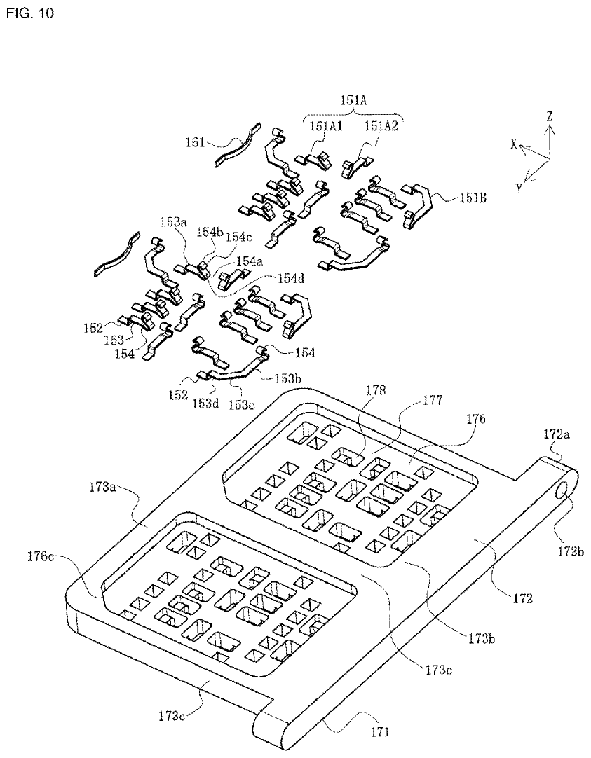

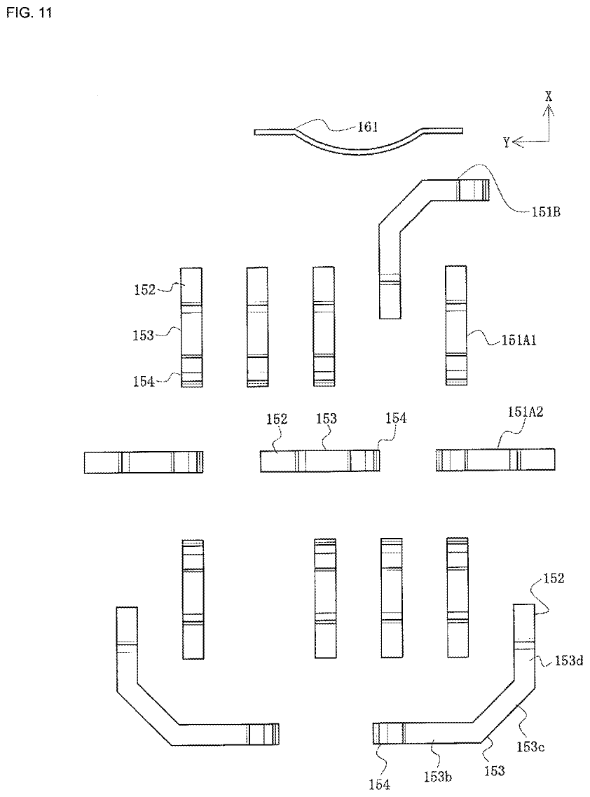

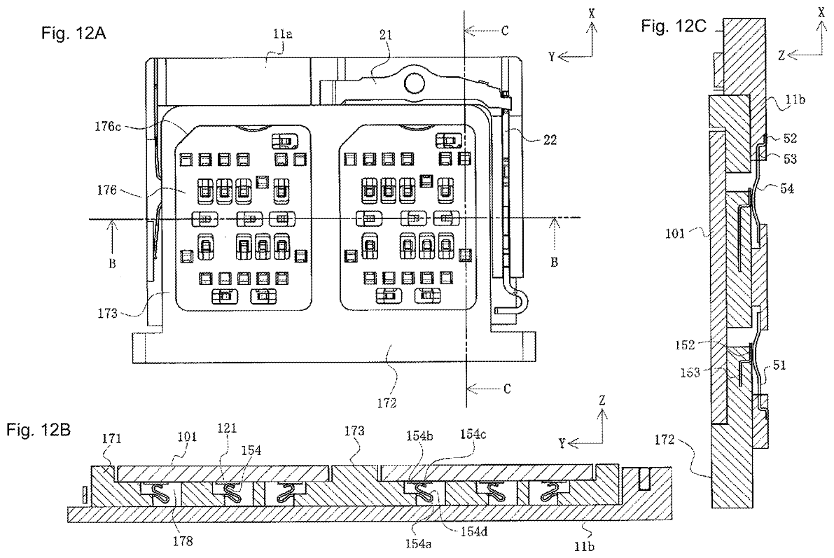

FIG. 8 is a perspective view of a card connector set in which a tray that is not holding a card is inserted into the connector according to embodiment 2, in a state where the connector cover has been removed. FIG. 9 is a bottom view of the card according to embodiment 2. FIG. 10 is an exploded view of the tray according to embodiment 2. FIG. 11 is an upper surface view illustrating the arrangement of the tray terminals according to embodiment 2. FIGS. 12A, 12 B and 12c are views of a card connector set in which a tray is inserted into the connector according to embodiment 2, in a state where the connector cover has been removed. Note that, FIG. 12A is an upper surface view in a state where a card is not being retained, FIG. 12B is a sectional view taken along the line B-B of FIG. 12A and illustrates a state in which a card is retained, and FIG. 12C is a sectional view taken along the line C-C of FIG. 12A and illustrates a state in which a card is retained.

As illustrated in FIG. 9, the electrode pad 121 of the card 101 according to the present embodiment includes a plurality of types of shapes and sizes and is arranged so as to form a plurality of rows and a plurality of columns in a plan view. In the example illustrated in FIG. 9, the electrode pads 121 constitute five rows of first to fifth rows (lines 1 to 5) and five columns of first to fifth columns (columns 1 to 5). However, the electrode pads 121 do not necessarily need to be present in positions corresponding to all columns in each row, and are not necessarily present at positions corresponding to all rows in each column. In other words, the electrode pads 121 are not arranged to correspond to all of the matrix components consisting of the first to fifth rows and the first to fifth columns. Here, if necessary, the electrode pad 121 present at a position corresponding to the component (i, j) in the ith row and the jth columns is designated as the electrode pad 121 (i, j).

If the card 101 is made smaller, thinner, and multi-polarized, such as a nano-SIM card (nSIM card), placing a number of same shaped and sized electrode pads 121 closely side-by-side and arranged on the underside of the card 101 to form a small number of rows of approximately 1 to 2 rows can be difficult, requiring the placement of a variety of shapes and sizes of electrode pads 121 to be positioned only at certain select positions from components within the matrix of a plurality of rows and columns as in the example illustrated in FIG. 9.

In such a case, the arrangement of the connection pads exposed on the top surface of the circuit board of the electronic device is similar to embodiment 1 for wiring of the circuit board, and thus the corresponding arrangement of the connector terminals 51 is the same as in the first embodiment. Note that configurations and operations of other components of the connector 1 of the present embodiment are the same as those of embodiment 1, and the descriptions thereof will be omitted.

Since the tray 170 in the present embodiment is the same as the first embodiment except for the tray terminal housing recess 178 formed in the bottom wall part 177 of the tray housing 171 and the tray terminal 151 housed in the tray terminal housing recess 178, the description of the configuration of the tray 170 other than said tray terminal housing recess 178 and tray terminals 151 will be omitted.

Similar to the electrode pads 121 of the card 101, the tray terminal housing recesses 178 in the present embodiment are arranged so as to constitute five rows and five columns, but are not necessarily present at positions corresponding to all columns in each row, and not necessarily at positions corresponding to all rows in each column. In other words, the tray terminal housing recesses 178 is not necessarily all of the components of the matrix consisting of the first to fifth rows and the first to fifth columns, but is arranged in the components corresponding to the electrode pads 121.

Similar to the electrode pads 121 of the card 101, the second contact part 154 of the tray terminals 151 in the present embodiment are arranged so as to constitute five rows and five columns, but are not necessarily present at positions corresponding to all columns in each row, and not necessarily at positions corresponding to all rows in each column. In other words, the second contact parts 154 of the tray terminals 151 are not necessarily all of the components of the matrix consisting of the first to fifth rows and the first to fifth columns, but are arranged in the components corresponding to the electrode pads 121. Note that each of the second contact parts 154 of the tray terminals 151 are housed in the corresponding tray terminal housing recess 178.

The tray terminal 151 in the present embodiment includes a type 1 tray terminal 151A and a type 2 tray terminal 151B. The type 1 tray terminal 151A has the same configuration as the tray terminal 151 in embodiment 1, but includes posture, the first of which being the same as the tray terminals 151 in embodiment 1 being the column direction tray terminal 151A1 arranged in a manner controlled extending in the front-rear direction (insertion and ejection direction of the tray 170, or in other words the X-axis direction) the second of which being the row direction tray terminal 151A2 arranged in a manner controlled to extend in the left-right direction (the width direction of the tray 170, or in other words the Y-axis direction).

The column direction tray terminals 151A1 are arranged so that, in plan view, the main body part 153 that connects the first contact part 152 that contacts the connector terminals 51 and the second contact part 154 that contacts the electrode pads 121 extends in the front-rear direction (the column direction of the matrix). Thus, in a state where the tray 170 is inserted into the connector 1, the column direction tray terminals 151A1 cause conduction of the connector terminals 51 positioned along a straight line extending in the front-rear direction in plan view with the electrode pads 121.

In contrast, the row direction tray terminals 151A2 are arranged so that, in plan view, the main body part 153 that connects the first contact part 152 in contact with the connector terminal 51 and the second contact part 154 in contact with the electrode pad 121 extends in the left-right direction (the row direction of the matrix). Thus, in a state where the tray 170 is inserted into the connector 1, the row direction tray terminals 151A2 cause conduction of the connector terminals 51 positioned along a straight line extending in the left-right direction in plan view with the electrode pads 121.

On the other hand, the main body part 153 of the type 2 tray terminal 151B does not extend linearly in plan view like the tray terminal 151 in embodiment 1 and the main body part 153 of the type 1 tray terminal 151A, but also includes a portion extending in the front-rear direction and a portion extending in the left-right direction. Specifically, the main body part 153 of the type 2 tray terminal 151B includes a column direction portion 153d extending in the front-rear direction and a row direction portion 153b extending in the left-right direction. Note that in the example illustrated in the diagrams, while the row direction portion 153d is connected to the first contact part 152 and the row direction portion 153b is connected to the second contact part 154, the column direction portion 153d can be connected to the second contact part 154, and the row direction portion 153b can be connected to the first contact part 152. Additionally, the column direction portion 153d and the row direction portion 153b are connected by an incline direction portion 153c that extends in a direction that intersects with the front-rear direction and the left-right direction. Note that, if necessary, the column direction portion 153d and the row direction portion 153b can be directly connected, and the incline direction portion 153c may be omitted. In this way, the type 2 tray terminal 151b includes the column direction portion 153d and the row direction portion 153b, and thus, when the tray 170 is inserted into the connector 1, the connector terminal 51 and the electrode pad 121 at different positions in the front-rear direction and the left-right direction in plan view are made conductive.

In addition, as illustrated in FIG. 10 and FIG. 11 and similar to the tray terminal 151, the retaining part 161 in the present embodiment is a member formed integrally by forming such as punching, bending, or the like of a metal plate, but is not necessarily limited thereto; any type of member capable of elastic deformation can be used as long as a portion thereof protrudes into the recessed part 176, which is a housing space, and the side surface of the housed card 101 can be biased to retain the card 101.

Note that the configuration and operation of the other points of the card connector set in this embodiment are the same as those of the embodiment 1 described above, and therefore the description is omitted.

Thus, in the present embodiment, the tray terminal 151 includes, in plan view, a column direction tray terminal 151A1 arranged so that the main body part 153 extends in the insertion direction of the tray 170, and a row direction tray terminal 151A2 arranged so that the main body part 153 extends in the width direction orthogonal to the insertion direction of the tray 170. Further, in plan view, the at least one tray terminal 151 includes a column direction portion 153d arranged such that the main body part 153 extends in the insertion direction of the tray 170, and a row direction portion 153b arranged so that the main body part 153 extends in the width direction orthogonal to the insertion direction of the tray 170. Furthermore, the tray terminal 151 further includes an incline direction portion 153c that connects the column direction portion 153d and the row direction portion 153b.

This allows for compatibility with a card 101 in which electrode pads 121 of multiple shapes and sizes are arranged only in positions corresponding to a selected number of the components in a matrix of a plurality of rows and a plurality of columns.

Note that the present disclosure is not limited to the embodiments described above, and various modifications can be made on the basis of the spirit of the present disclosure and are not excluded from the scope of the present disclosure.

The present disclosure is only one example and can be appropriately changed as long as the spirit of the present disclosure is maintained, such that those which could have easily been conceived of by a person skilled in the art are included in the scope of the present disclosure. The width, thickness, shape, etc. of the parts illustrated in the drawings are schematically represented and do not limit the interpretation of the present disclosure.

### INDUSTRIAL APPLICABILITY

The present disclosure can be applied to a card retaining member and card connector set.

1. A card retaining member,
(a) that is capable of retaining a card provided with electrode pads and can be inserted into a card connector provided with connector terminals, comprising:
(b) a tray housing including a recessed part capable of storing the card, a bottom wall part defining the bottom surface of the recessed part, and a tray terminal housing recess formed in the bottom wall part, and
(c) tray terminals that are arranged on the bottom wall part, which include a main body part of which at least a portion is retained by the bottom wall part, a first contact part and second contact part that are connected to both ends of the main body part, respectively, of which the first contact part is contactable with the connector terminal and the second contact part is contactable with the electrode pad, wherein
(d) the first contact part is fixed and exposed on the surface on the opposite side to the bottom surface of the recessed part of the bottom wall part, and the second contact part is housed in the tray terminal housing recess in an elastically deformable manner where at least the point of contact is protruding from the bottom surface of the recessed part.

2. The card retaining member according to claim 1, wherein the second contact part is elastically deformable within the tray terminal housing recess without interfering with other members.

3. The card retaining member according to claim 1, wherein the tray terminals are arranged so as to form, in plan view, one or a plurality of rows in which the second contact parts are aligned along the width direction orthogonal to the insertion direction of the card retaining member.

4. The card retaining member according to claim 1, wherein the tray terminals are arranged such that, in plan view, the main body part extends in the insertion direction of the card retaining member.

5. The card retaining member according to claim 1, wherein tray terminals include, in plan view, a tray terminal arranged such that the main body part extends in the insertion direction of the card retaining member, and a tray terminal arranged such that the main body part extends in the width direction orthogonal to the insertion direction of the card retaining member.

6. The card retaining member according to claim 1, wherein at least one tray terminal includes, in plan view, a column direction portion arranged such that the main body part extends in the insertion direction of the card retaining member, and a row direction portion arranged such that the main body part extends in the width direction orthogonal to the insertion direction of the card retaining member.

7. The card retaining member according to claim 6, wherein the tray terminal further comprises an incline direction portion connecting the column direction portion and the row direction portion.

8. A card connector set, comprising:
(a) the card retaining member according to claim 1, and
(b) a card connector set that can be inserted into the card retaining member, and which is provided with a card connector provided with a connector terminal that is elastically deformable and includes a contact part contactable to the first contact part.

9. The card connector set according to claim 8, wherein the connector terminals are arranged such that each connector terminal extends in the insertion direction of the card retaining member, and contact parts form, in plan view, one or a plurality of rows aligned along the width direction orthogonal to the insertion direction of the card retaining member.
